(19) United States
(12) Patent Application Publication
(10) Pub. No.: US 2008/0226292 A1
(43) Pub. Date: Sep. 18, 2008

(54) Method and Processing Device for Transmitting Ethernet Service Signals in Wavelength Division Multiplexing Networks

(75) Inventors: Weishi Li, Guangdong (CN); Qianjin Xiong, Guangdong (CN); Jianmei Zhang, Guangdong (CN); Dianjun Xiao, Guangdong (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technology Co., Ltd., Shenzhen (CN)

(21) Appl. No.: 10/590,121

(22) PCT Filed: Mar. 9, 2006
(86) PCT No.: PCT/CN2006/000356

§ 371 Date: Aug. 13, 2007

(30) Foreign Application Priority Data
Mar. 9, 2005 (CN) 200510053621.7

(51) Int. Cl. H04J 14/00

(52) U.S. Cl. 398/48

(57) ABSTRACT

Disclosed is a method for transmitting Ethernet service signals in a Wavelength Division Multiplexing (WDM) network, including: a Center receiving Ethernet service signals and transmitting the signals to a transmission channel; a receiving station receives the Ethernet service signals, performs a space-division cross operation upon the received signals, duplicates the signals into two copies, where one is locally downloaded while the other is returned to the transmission channel. Three devices for processing the Ethernet service signals in the WDM network are provided. With the present invention, the broadcast of the Ethernet service signals with large granularity is implemented, therefore decreasing the delay for broadcast the real-time services; besides, it is not necessary anymore to construct a overlapped network with three layers of devices, i.e. a WDM system, a Synchronous Digital Hierarchy (SDH) system and a data device, so the network structure is simplified and management is convenient.

### FIELD OF THE TECHNOLOGY

The present invention relates to Wavelength Division Multiplexing (WDM) networks. More particularly, the invention provides a method and processing devices for transmitting Ethernet service signals in the WDM network.

### BACKGROUND OF THE INVENTION

With the development of IP technologies and the developing trend towards IP, more and more subscribers and operators adopt large amounts of large granularity services, e.g. implementing broadband data interconnections through 10M/100M Fast Ethernet (FE), Gigabit Ethernet (GE), 10 GE and other channels. Interfaces of large granularity services, e.g. GE interfaces, have become the mainstream interfaces of metropolitan broadband data service interconnections. Facing the ever emerging large amounts of GE interconnections, it is becoming more and more important to efficiently solve the transmission problem and to create a manageable and operationable telecommunication-level metropolitan network with low cost and guaranteed Quality of Service (QOS).

At present, one increasingly profitable area of the broadband services is Internet Protocol TV (IPTV) services, which is also called network TV or broadband TV, the IPTV provides interactive multimedia services for the subscribers by the broadband networks.

The IPTV includes multiple services, but are divided into unicast service and multicast service in terms of the service flow type. FIG. 1 is a schematic diagram illustrating the transmission of a drop and continue service required by the IPTV. When the service from a Center Server (CS) of TV programs need to be multicast to downstream stations, the service will be sent all the way to an Edge Server (ES) device of the station (drop) after the GE channel arrives at the downstream station, and the GE needs to be continuously sent to another downstream station (continue). The ES is a TV reception processing device in the IPTV network, which can be divided into a central server ES and an edge server ES. The ES is used for locally storing the broadcast data and plays the broadcast data to users close at hand. Generally, the service is bore through the GE channel; when the GE channel is broken off, the service is switched to a protection channel on the reverse-direction to continuously transmit the service to the destination.

In the prior art, the multicast service is implemented through the following methods to transmit Ethernet service signals.

The prior art 1: implementing the multicast of the GE channels based on 1:N optical splitters.

As to the GE channels to be broadcast, a source terminal of the Center adopts the 1:N optical splitter to divide one line of signals into N lines that are completely the same, and then sends the signals to different stations or clients by way of fiber direct connection, and signals are amplified at receiving ends by optical amplifiers.

The prior art 2: implementing the multicast of the GE channels based on 1:2 optical splitters.

One line of the optical signals is divided into two lines by the 1:2 optical splitters, wherein one copy is sent to a local station while the other copy is sent to a next station, the signals can be amplified by the optical amplifiers when the power is inadequate.

The prior technique 3: implementing the multicast by Virtual Channels (VCs) based on Synchronous Digital Hierarchy (SDH).

When the VC channels are adopted for a cross broadcast, each station has an SDH cross unit, through which the SDH device can broadcast the service based on the VC12 channel and VC4 channel, etc.

The prior technique 4: the multicast based on data devices.

In the method, an IP multicast adopts a best-effort transmission way to transmit IP packets of the service data to a certain subset of nodes in the network; a source host transmits a copy of information and the destination address of the information is a multicast address; all receivers in the multicast group can receive the same data, and only the hosts in the multicast group rather than others can receive the data; the multicast group is identified by a D-class IP address and is implemented by multicast protocols, e.g. an Internet Group Management Protocol (IGMP) snooping, etc.

### SUMMARY OF THE INVENTION

The present invention is to provide a method and processing devices for transmitting Ethernet service signals in a Wavelength Division Multiplexing (WDM) network, which can implement multicast of large granularity Ethernet service signals in the WDM network conveniently and reduce the delay when multicasting the real-time service.

The present invention provides a method for transmitting the Ethernet service signals in the WDM network, including:

a Center Server (CS) receiving the Ethernet service signals and transmitting the signals to a transmission channel;

a receiving station receiving the Ethernet service signals from the transmission channel, performing a space-division cross upon the received signals and duplicating the signals into two copies, wherein one copy is locally downloaded and the other copy is returned to the transmission channel for continuous transmission.

The present invention provides a processing device for transmitting the Ethernet service signals in the WDM network, including:

transmitting/receiving modules that connect the transmission channels in the WDM network;

a local service processing part that connects to a user side; and

a space-division cross module, connected with the transmitting/receiving modules and the local service processing part, and is used for performing the space-division cross upon the Ethernet service signals and duplicating the Ethernet service signals;

wherein, the Ethernet service signals at network side received by the transmitting/receiving module are duplicated by the space-division cross module into two copies, one copy is transmitted to the local service processing part and the other copy is returned to the network side for continuous transmission.

The present invention also provides a processing device for transmitting the Ethernet service signals in the WDM network, including:

the transmitting/receiving modules, which are connected with the transmission channels of the WDM network;

a Media Access Control (MAC) layer that connects to the user side; and

the space-division cross module, connected with the transmitting/receiving modules and the MAC layer, and is used for performing the space-division cross upon the Ethernet service signals;

wherein, the MAC layer is used to duplicate the Ethernet service signals from the space-division cross module into two copies, wherein one copy is sent to the local station while the other copy is returned to the transmission channel of the WDM network through the space-division cross module and the transmitting/receiving modules.

The present invention provides a processing device for transmitting the Ethernet service signals in the WDM network, including:

the transmitting/receiving modules, which are connected with the transmission channels in the WDM network;

the local service processing part, which is connected with the user side; and the space-division cross module;

a network identifier module, which is used for indicating, identifying and peeling the identifier;

wherein, the space-division cross module is connected with the transmitting/receiving modules and the network identifier module, and is used for performing the space-division cross function upon the Ethernet service signals;

the network identifier module is used to duplicate the Ethernet service signals into two copies, it removes the identifier of one copy and sends the signals to the local service processing part, while returns the other copy to the transmission channel of the WDM network through the space-division cross module and transmitting/receiving modules for continuous transmission.

With the method and devices of the present invention, the following favorable technical effects can be achieved:

1. multicast of different capacity levels, such as large, medium or small granularity can be satisfied, and the multicast requirement of the video service in the Internet Protocol TV (IPTV) can be satisfied;

2. through the transmission channel provided by the WDM network, large number of GE channels can be conveniently multicast to receiving stations, so that video services that require high quality can be transmitted in real-time by making use of the large-capacity character of WDM, therefore lower the transmission cost;

3. when a plurality of Gigabit Ethernets (GEs) share one channel to transmit, services with lower priorities can be transmitted first so as to improve the bandwidth utilization;

4. it is not necessary anymore to construct the overlapped network with the WDM systems, the SDH systems and the data devices, so that network hierarchy is simple with convenient management and maintenance.

### BRIEF DESCRIPTION OF THE DRAWINGS

FIG. 1 is a schematic diagram illustrating the transmission of a drop and continue service requested by the IPTV;

FIG. 2 is a schematic diagram illustrating the structure of a device for processing Ethernet service signals in the present invention;

FIG. 3 is a schematic diagram illustrating the structure of a device according to a first embodiment of the present invention;

FIG. 4 is a schematic diagram illustrating the structure of another device according to the third embodiment of the present invention;

FIG. 5 is a schematic diagram illustrating still another device of the present invention;

FIG. 6 is a schematic diagram illustrating the yet another device of the present invention;

FIG. 7 is a flowchart illustrating a method according to an embodiment of the present invention;

FIG. 8 is a flowchart illustrating the procedure of the CS transmitting services according to a first embodiment of the present invention;

FIG. 9 is a flowchart illustrating the procedure of an ES receiving services according to the first embodiment of the present invention;

FIG. 10 is a flowchart illustrating the procedure of multicasting different services through the GE channels according to the first embodiment of the present invention;

FIG. 11 is a flowchart illustrating the edge station's receiving services according to the second embodiment of the present invention;

FIG. 12 is a flowchart illustrating the procedure of multicasting multiple services with different VLAN labels through a shared channel according to the second embodiment of the present invention;

FIG. 13 is a flowchart illustrating the procedure of multicasting multiple services with different station identifiers through a shared channel according to the third embodiment of the present invention.

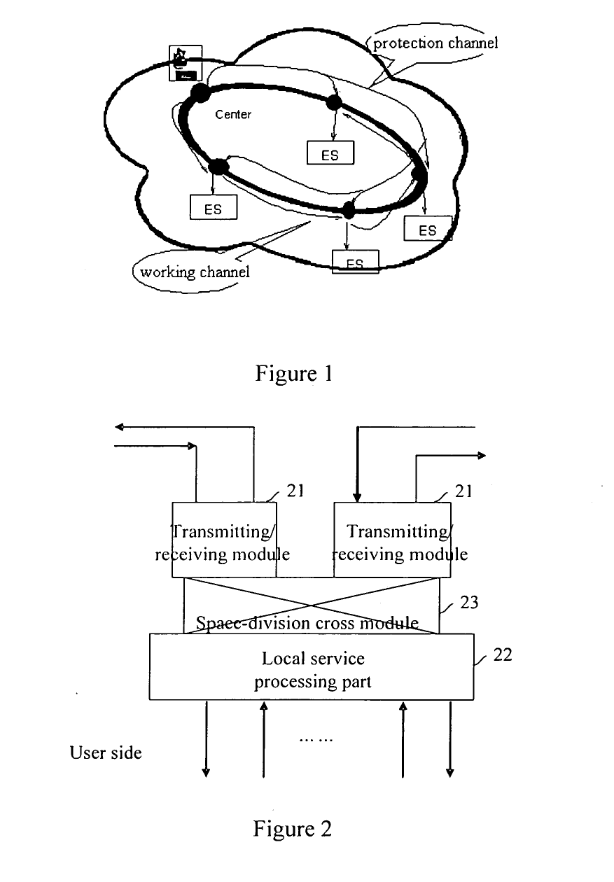

### DETAILED DESCRIPTION OF THE INVENTION

In order to make the technical scheme and advantages of the present invention clearer, the present invention will be illustrated in detail hereinafter with reference to the accompanying drawings.

To implement the method for multicasting the IPTV service in the WDM network, a new service signal processing device is needed. To make the illustration simple, take GE as an example, and other Ethernet service signals, such as FE, 10 GE, etc., can be implemented following the same or similar method.

As shown in FIG. 2, the device for processing the Ethernet service signals mainly includes transmitting/receiving modules 21 which connect to the transmission channels of the WDM network, a local service processing part 22 and a space-division cross module 23 which connects to the transmitting/receiving modules 21 and the local service processing part 22.

Wherein, the above-mentioned Ethernet signals processing device receives the Ethernet service signals from the transmission channel of the WDM network through the transmitting/receiving modules 21, and then performs a space-division operation upon the Ethernet service signals and duplicates the signals into two copies through the space-division cross module 23, one copy is sent to the local service processing part 22 and the other copy is returned to the transmission channel of the WDM network for continuous transmission.

The above-mentioned local service processing part 22 can includes a MAC layer and a physical layer. The MAC layer is used for a layer 2 switch based on a VLAN and bandwidth control, and further used for selecting services that belong to the present station to receive according to labels in packet headers. The above-mentioned local service processing part 22 can also include a network identifier module that is used for selecting services that belong to the present station to receive according to the identifiers added to the packet headers; accordingly in the MAC layer, therefore, the process of selecting services that belong to the present station according to labels in the packet headers is not performed in the MAC layer, the received packets can be directly processed. In addition, between the space-division cross module and the transmitting/receiving port, the Ethernet service signal processing device can include an encapsulation module and a mapping/framing module. The Ethernet service signal processing device as in the present invention will be illustrated in detail hereinafter with reference to specific embodiments.

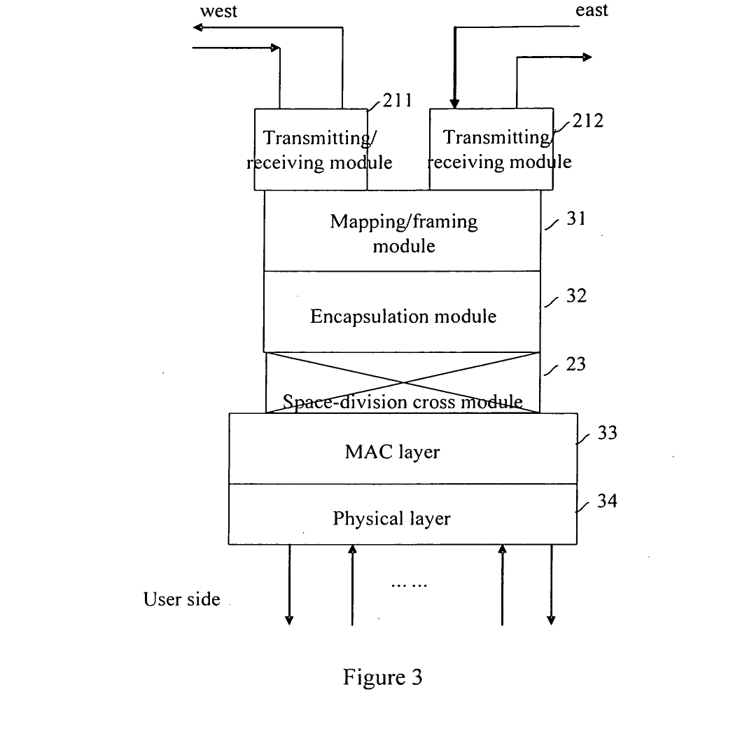

A first embodiment of the Ethernet service signal processing device as in the present invention is shown in FIG. 3, the device includes a west transmitting/receiving module 211, an east transmitting/receiving module 212, the mapping/framing module 31, the encapsulation module 32, the space-division cross module 23, the MAC layer 33 and the physical layer 34.

Wherein, the west transmitting/receiving module 211 and the east transmitting/receiving module 212 are physical interfaces of the WDM lines, and are used for implementing electric/optical and optical/electric conversions; there are two parallel pairs of the west and east transmitting/receiving modules to satisfy the need of bi-directional receiving and transmitting, and the two pairs of the modules are used for receiving the Ethernet service signals from the transmission channel of the WDM network and transmitting the received signals to the mapping/framing module 31 respectively, or receiving the signals from the mapping/framing module 31 and transmitting the signals to the transmission channel of the WDM network.

The mapping/framing module 31 is used for de-mapping the high speed service signals from the west transmitting/receiving module 211 or the east transmitting/receiving module 212 into low speed service signals, and transmitting the low speed signals to the encapsulation module 32; or mapping and framing the low speed service signals from the encapsulation module 32 into high speed services, e.g. mapping a 1.25 G GE service to a 2.5 G service or a 10 G service or a service with a higher speed.

The encapsulation module 32 is used for decapsulating the low speed service signals from the mapping/framing module 31 and transmitting the decapsulated signals to the space-division cross module 23; or encapsulating the service signals from the space-division cross module 23 and transmitting the encapsulated signals to the mapping/framing module 31. The encapsulation can be implemented by a General Framing Procedure (GFP) or other ways.

The rate of the channel transmitted on the WDM line is probably higher than that of the channel of the local service signals, therefore, after the processing of the above-mentioned encapsulation module 32 and the mapping/framing module 31, the high speed signals on the WDM line can be transformed into low speed signals that the local device can process; and the low speed signals that the local device can process can also be transformed into high speed signals on the WDM line.

The space-division cross module 23 is used for crossing the service signals from the encapsulation module 32 and duplicating the signals into two copies, one copy is sent to the encapsulation module 32 and the other copy is sent to the MAC layer 33. Wherein, the space-division cross module 23 can adopt the format of a switching matrix, to duplicate the data by inputting the data from one port and outputting two copies through two ports. By duplicating the signals and transmitting the duplicated signals to the local MAC layer 33 and to the WDM network through the encapsulation module 32 respectively, the space-division cross module 23 can drop and continue to transmit the multicast services. As to the GE service, the space-division cross module 23 can be called a GE Add/Drop Multiplexer (ADM) module.

The function of the MAC layer 33 in the present embodiment is the same as that in the prior art, e.g. used for service bandwidth control, VLAN-based layer 2 switching, etc.

The function of the physical layer 34 in the present embodiment is also the same as that in the prior art, it processes the layer 2 data from the MAC layer 33. The physical layer 34 includes a physical interface between the Ethernet service signal processing device and the client, and is used for implementing the optical/electric or the electric/optical switch, timing and relevant detection functions at the client side.

As to the Ethernet service signals processing device according to the second embodiment of the present invention, the structure of the device is the same as that in the first embodiment, the difference is that, in the second embodiment, except for the functions in the first embodiment, the MAC layer 33 is further used for receiving the service packets that belong to the present station according to the configured forwarding table which includes packet labels, i.e. the corresponding relationships between MAC labels and output ports, and the MAC layer 33 discarding other service packets from the space-division cross module 23.

The above-mentioned packet labels can be Multi-Protocol Label Switch (MPLS) labels, Resilient Packet Ring (RPR) labels or VLAN labels. Since the MPLS label needs signaling protocol to create label switch channels, and the RPR label needs topology discovery, fair algorithms, etc., the processing is relatively complicated. However, the VLAN label needs no protocol. It just needs to configure the forwarding table at each node, so that it implements the forwarding or duplication by searching the corresponding exports to the packets according to the forwarding table. Therefore, the VLAN label is a preferable choice. If the MPLS label or the RPR label is adopted to implement the above-mentioned two embodiments, after the protocol and algorithms, the final forwarding or duplication methods are basically the same as those when adopting the VLAN label. Both of them search the forwarding table for the corresponding export according to the label and transmit the packets through the export.

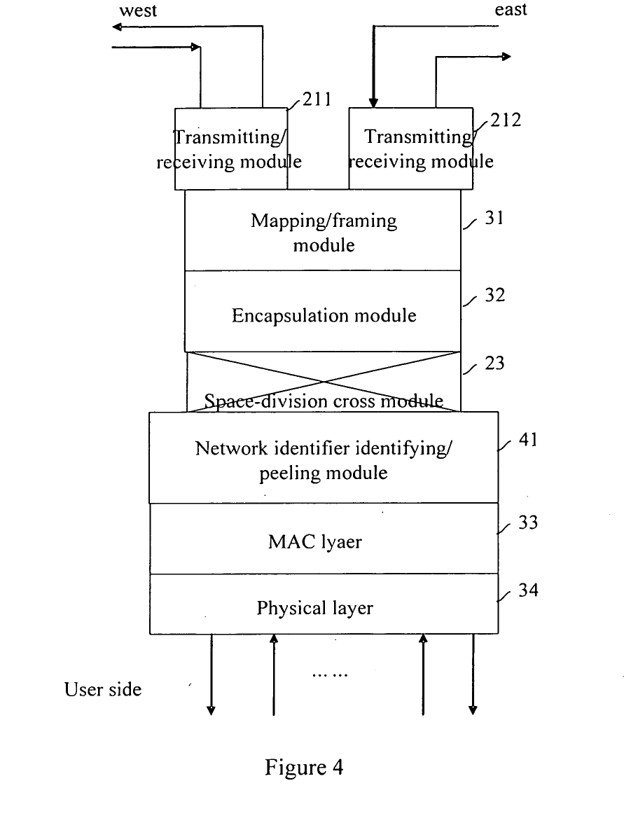

The structure of the Ethernet service signal processing device in the fourth embodiment of the present invention is shown in FIG. 4. It can be seen from FIG. 4 that, except for the modules in FIG. 3, the device of the present embodiment further includes the network identifier module 41, which connects the space-division cross module 23 and the MAC layer 33, and is used for adding or peeling the identifier from packet header, receiving services of the present station and discarding other services according to the identifier. Specifically: the network identifier identifying/removing module 41 adds an identifier, which corresponds to the receiving station and/or the port number of the receiving station, to the service packets from the MAC layer 33 at the source station; and receives the duplicated packets from the space-division cross module 23, receives the services that belong to the present station and/or the port of the present station according to the identifier added to the received packet header, and peels the identifier of service packet that belongs to the present station and/or the port of the present station before transmitting the packets to the MAC layer 33. The functions of other modules are the same as those in the first embodiment.

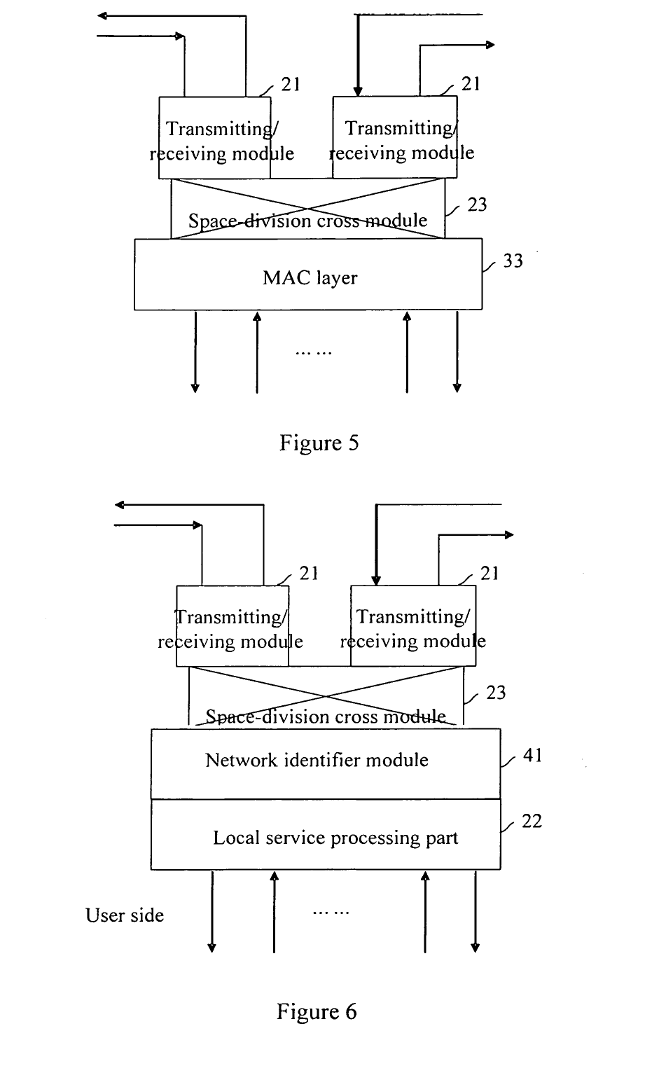

As shown in FIG. 5, another type of device for processing Ethernet service signals is also provided, which includes: the transmitting/receiving modules 21 that connect the transmission channels of the WDM network, the MAC layer 33, and the space-division cross module 23 which connects the transmitting/receiving modules 21 and the MAC layer 33.

Wherein, the above mentioned Ethernet service signal processing device receives the Ethernet service signals from the transmission channel of the WDM network through the transmitting/receiving modules 21, performs the space-division cross upon the Ethernet service signals through the space-division cross module 23 and then transmits the signals to the MAC layer 33; the MAC layer 33 duplicates the Ethernet service signals from the space-division cross module 23 into two copies, wherein one copy is transmitted to the local station while the other copy is returned to the transmission channel of the WDM network through the space-division cross module 23 and the transmitting/receiving modules 21 for continuous transmission.

The structure of the above-mentioned Ethernet service signal processing device is basically the same as that shown in FIG. 3, the difference is that, in the present embodiment, the space-division cross module 23 only performs the space-division cross upon the received data and provides a flexible GE channel penetration function without duplicating the data. The MAC layer 33 is further used for forwarding the packets received from the space-division cross module 23 to the physical layer 34 through the local port corresponding to the label, and meanwhile returning the received packets to the space-division cross module 23 through the other port corresponding to the label, according to the forwarding table which configures the local export and the port to return to the space-division cross module 23 corresponding to each packet.

In the present embodiment, except for the above-mentioned function, the MAC layer 33 can be further used for receiving services that belong to the present station according to the forwarding table which includes the corresponding relationship between the packet label and exports, and discarding other service packets from the space-division cross module 23.

As shown in FIG. 6, a third type of Ethernet service signal processing device is also provided, which includes: the transmitting/receiving modules 21 that connect the transmission channels of the WDM network, the space-division cross module 23, the network identifier module 41 and the local service processing part 22.

Wherein, the above-mentioned Ethernet signal processing device receives the Ethernet service signals from the transmission channel of the WDM network through the transmitting/receiving modules 21, performs the space-division operation upon the Ethernet service signals through the space-division cross module 23 and then transmits the signals to the network identifier identifying/removing module 41. The network identifier identifying/removing module 41 duplicates the Ethernet service signals from the space-division cross module 23 into two copies according to the identifier added to packet header of the service signals and the forwarding table, one copy is sent to the local service processing part 22 and the other copy is returned to the transmission channel of the WDM network for continuous transmission.

The structure of the device in the present embodiment is the same as that in FIG. 4, wherein, the differences of the functions of the modules in FIG. 4 from those in FIG. 3 are: the space-division cross module 23 only performs the space-division upon the received data and provides the flexible GE channel penetration function without duplicating the data. Except for adding, peeling the identifier, the network identifier identifying/removing module 41 is further used for forwarding the packets received from the space-division cross module 23 to the MAC layer 33 through the local port corresponding to the label, and meanwhile returning the received packets to the space-division cross module 23 through the other port corresponding to the label, according to the forwarding table which configures the local export and the port to return to the space-division cross module 23 corresponding to each packet.

In the present device, the MAC layer 33 can be further used for receiving services that belong to the present station according to the forwarding table that include the corresponding relationship between the packet label and exports, and discarding other service packets from the space-division cross module 23. In addition, the alternative process is: the network identifier module 41 duplicates and forwards the Ethernet service signals according to the forwarding table, and meanwhile directly returns the service signals to the space-division module without selection; as to the Ethernet service signals forwarded to the MAC layer, the network identifier module 41 selects the services that belong to the present station while discards other services.

In the above-mentioned two devices, although both of the space-division cross module and the MAC layer can implement data duplication, the data duplication implemented by the space-division cross module is of shorter delay and better transparent quality, so the space-division cross module is a preferable choice.

The above provided devices used in the WDM network combine the advantages of the space-division technologies and the WDM technologies and implement the drop and continue transmission required by the IPTV multicast service, so that the IPTV multicast service has shorter delay and better transparent quality, the large-capacity bandwidth is implemented and network structure is simple. With the devices of the present invention, it is not necessary anymore to construct the overlapped networks with the WDM systems, the SDH systems and the data devices, and the network can be constructed only by the WDM network, so that the network hierarchy is simple, the management and the maintenance is convenient.

The device of the present invention has been illustrated as above, the method of the present invention for transmitting the Ethernet service signals in the WDM network will be illustrated in detail hereinafter.

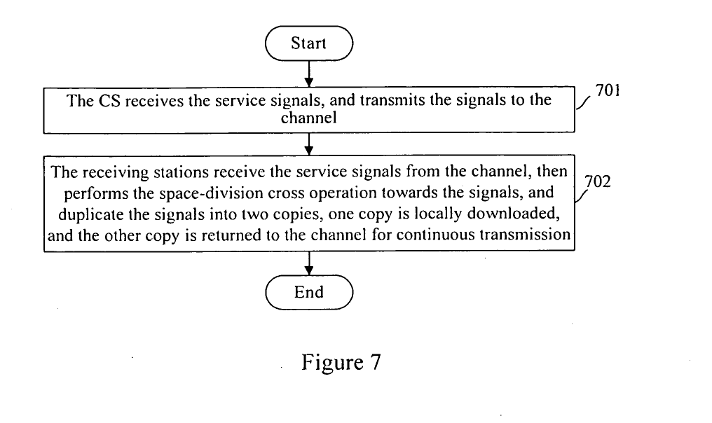

As shown in FIG. 7, the method of the present invention mainly includes the following steps:

Step 701: a CS receiving the Ethernet service signals and transmitting the signals to a transmission channel;

Step 702: the receiving station receiving the Ethernet service signals from the transmission channel, performing a space-division cross upon the received signals and duplicating the signals into two copies, wherein one copy is downloaded locally and the other copy is returned to the transmission channel for continuous transmission.

In the above-mentioned step 702: the duplication of the received signals can be implemented by the space-division cross module or implemented by the MAC layer after the received signals is processed by the space-division cross module. In addition, as to the locally downloaded service signals, the receiving station can identify and receive the services that belong to itself according to the MAC layer label in the signals or the identifier added to the signals while discard the services not belonging to itself.

The method for transmitting the Ethernet service signals in the WDM network will be illustrated hereinafter with reference to several specific embodiments. Supposing that there are 6 stations in the WDM network, for the sake of simplicity, the GE service is taken as an example. A is the CS of the network and it is also the source station of the multicast; the other 5 are receiving stations or edge stations; and each station is equipped with the device for multicast in the preset invention. Each embodiment will be illustrated according to the service procedure of the CS and that of the edge station respectively.

The first embodiment: implementing the GE channel multicast in the WDM network.

Implementing the multicast of large granularity GE service by an ADM technique based on the GE. With the technique, the GE service from the CS is multicast to the downstream edge stations through the GE channels provided by the WDM system; meanwhile, the GE-based ADM cross module, i.e. the above-mentioned space-division cross module which is shortened as the GE ADM cross module, implements to drop, duplicate and continuously transmit the GE service to the downstream stations.

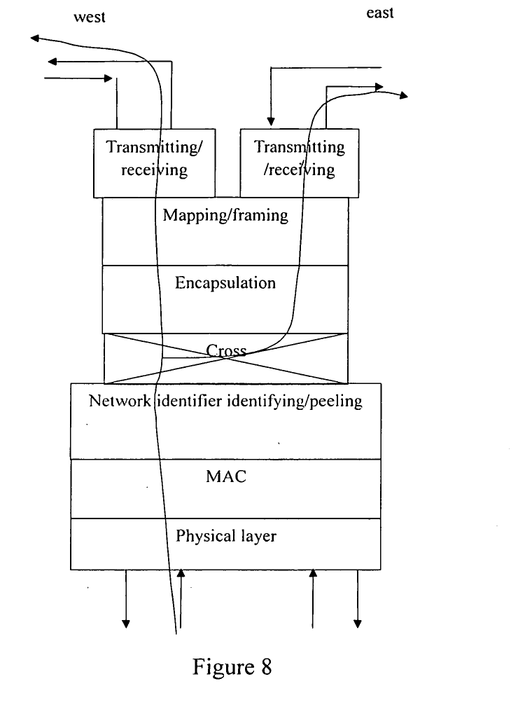

At the service transmission side, as shown in FIG. 8, at the source station, the service from the client enters into the WDM system through the physical layer interface, the GE service in embodiment 1 only requires the GE channel multicast, so it is not necessary for the MAC to especially process the service; in the GE ADM cross module, the received GE service signals are processed by the GE ADM cross function and then encapsulated, mapped and framed, and after that, the GE service signals can be output through the west optical interface or through the east optical interface. If the network is in normal condition, the multicast service receiving stations only need to receive one of the west and the east signals, and the source station can send only one line of the service, either to the west or to the east, when the network breaks down and protection switch is needed, the GE ADM cross module will perform the switch process; assuming that the service is received from the west in normal conditions, when malfunction is detected in the west, e.g. the west receiving module or the service encapsulation module breaks down, the GE ADM cross module will perform the switch process; or the GE ADM cross module distributes the signals from the client into two copies and sends the two copies to both the west and the east. Therefore, the east output receiving module and the west output receiving module can be configured in one direction or two directions.

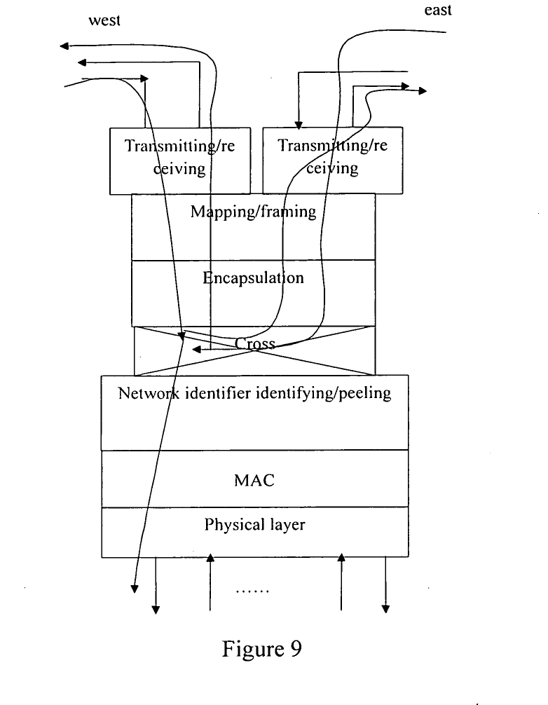

At the service reception side, the flowchart in FIG. 9 illustrates the function module of the multicast service receiving station. The module connects the two directions of the ring network, i.e. the west and the east. In normal conditions, the west service and the east service are input through respective receiving modules, and are reverted to the GE signals after de-multiplexing and de-capsulation, then the reverted GE signals are input into the GE ADM cross module. The GE ADM cross module selects a service to receive. Assuming that the west service is received, the west GE service is duplicated in the GE ADM cross module into two copies, one of which is sent to the client while the other copy is returned by the GE ADM cross module and output by the east sending module after encapsulation, mapping and framing. The process of the east service is reverse. Therefore, the GE signals from the ring network is dropped in the present station and continued to be transmitted to the next station through the WDM line after duplication, thus the drop and continuous transmission is realized.

In this method, the GE ADM cross module can select to receive the east or the west service, so the module has the protection switch function. Taking the station D for example, in normal conditions, the station D receives the service signals from its right side (the east), then the GE ADM cross module will send the service signals from the east to the client and output the service signals to the station E through the west fiber after duplicating the service signals. If the fiber between the station B and the station D breaks down, the station D cannot receive the service signals from the station C. Instead, it will receive the service from the station E on its left (the west). Then the GE ADM cross module in the station D will send the service signals from the west to the client, meanwhile duplicate the GE and output it to the station C through the right side (east) fiber. Thus, the GE ADM cross module implements service selection, protection switch and the GE channel duplication.

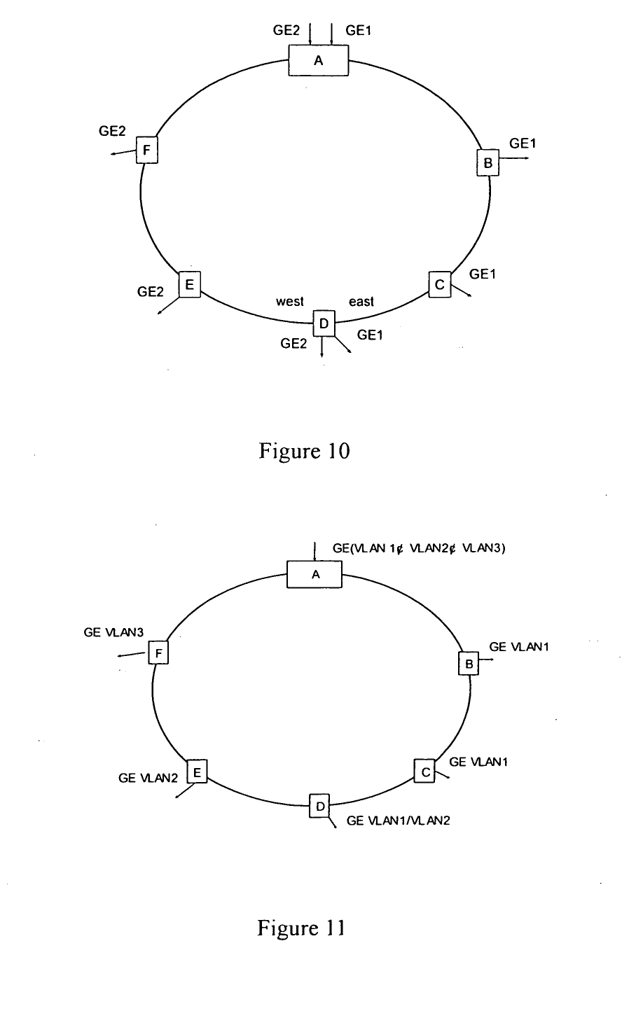

FIG. 10 is a network topology of the first embodiment and a flowchart illustrating the procedure of multicasting different services through the GE channels to different receiving stations in the first embodiment of the present invention. GE1 is multicast to station B, C and D, while GE2 is multicast to station D, E and F.

In this way, as to the IPTV or the digital TV, the service devices can distribute video services to different GE channels and the number of GE channels increases with the video services. The source station needs to multicast programs to the downstream stations, wherein, with the WDM system as in the present invention on the transmission link, it is possible to multicast large amounts of GE channels to the receiving stations conveniently. Therefore the video services that require high quality can be transmitted in real-time by making use of the large-capacity of the WDM, and the transmission cost is reduced accordingly.

The second embodiment: implementing the multicast in the WDM network based on the MAC layer label carried in the service.

The MAC layer labels includes VLAN labels, MPLS labels, or RPR labels, etc. wherein, the VLAN label is the most convenient, so the embodiment will be illustrated with the VLAN label as an example.

When the upstream service of the CS is the GE service that includes different VLAN labels, in order to improve the bandwidth utilization, the WDM will multicast the GE service to different downstream stations in a shared channel according to the VLAN labels and the difference of the VLAN labels.

The function of the CS in the present embodiment is the same as that in the first embodiment, and the specific process is shown as FIG. 9. The GE service from the source station includes different VLAN labels, the east/west service selection and the service duplication are the same as those in the first embodiment. The difference lies in that the MAC layer of the source station in the second embodiment needs to identify the VLAN labels carried in the Ethernet service signals which are received by each receiving station, and the MAC layer correspondingly notify each receiving station through a control channel; each receiving station configures the forwarding table which includes the corresponding relationship between the VLAN label and the port according to the received notification, and sets the port corresponding to the VLAN label of the service packets that belong to the present station as the local port. The MAC layer of the receiving station selects, through the VLAN label, the service signals that belong to the present station to locally download according to the configured forwarding table, and discards the services not belonging to the present station, however, in the first embodiment, the selection procedure according to the VLAN label is not necessary.

As shown in FIG. 11, the source station receives three services from the client side that carry different VLAN labels and multicasts the services to the downstream stations. Each downstream station identifies the services of the present station through the VLAN labels, and then continues to transmit the service to the next station on the WDM line after dropping and duplicating the service. Due to the different VLAN labels in the service, several services with low-priority can share one GE channel to transmit so as to improve the bandwidth utilization; the bandwidth is equally compressed by the VLAN multicast.

In the present embodiment, the services with different priorities can share different GE channels respectively, e.g., the services with high priority share the GE channel 1 while services with low priority share the GE channel 2 and then different protection strategies are performed upon the GE channel 1 and GE channel 2.

In the present embodiment, the duplication of Ethernet service signals can also be implemented by the MAC layer, thus two ports need to be configured for each MAC layer label in the forwarding table of the MAC layer, one port of which is a local export while the other port is for returning service signals to the WDM network channel through the space-division cross module. As to the service signals not belonging to the present station, the local export can be configured as null. The space-division cross module only performs the space-division cross upon the service signals, the MAC layer outputs the services through the corresponding port according to the forwarding table after duplicating the service signals.

The third embodiment: implementing the service multicast in the shared channel based on self-defining identifiers of the WDM network.

In order to improve the bandwidth utilization, a set of identifier information of stations and ports can be defined in the WDM network to differentiate the Ethernet service signals that are sent to different stations in the shared Ethernet channels.

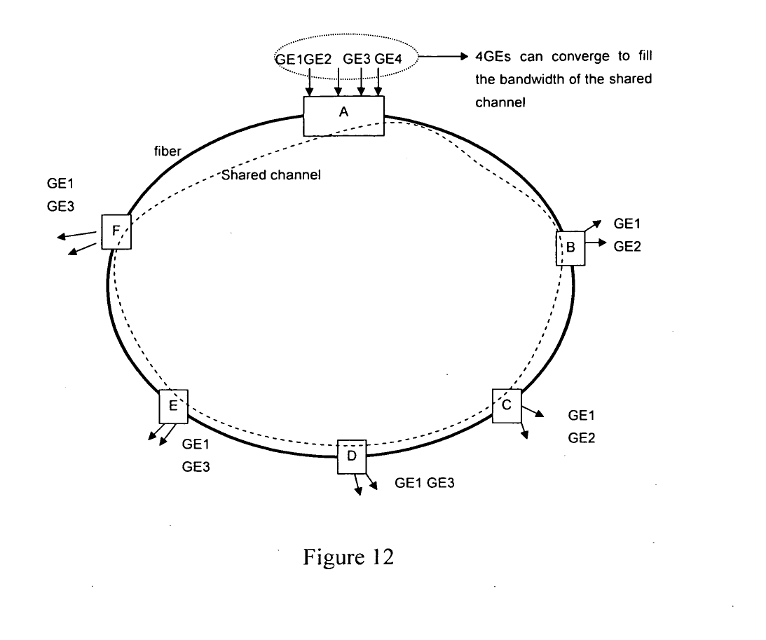

As shown in FIG. 12, the CS has 4 GEs that are transmitted in the WDM system through one or several shared GE channels. These 4 GEs will be multicast to different stations. Wherein, the source station needs to control the bandwidth of the service in the MAC layer based on the VLAN, etc., so as to limit the bandwidth of the WDM line within a predefined capacity, since several GEs share one or more GE channels, e.g. share one GE channel, in order to differentiate the upstream services from different ports in the shared channel, and in order to make the receiving station differentiate the downstream services that arrive at different receiving ports in the shared channel, in a WDM network identifier layer as in the embodiment, the services from the 4 GEs need to be identified and differentiated, e.g. identifying the services by 1, 2, 3 and 4, the services are output through the space-division cross module to the west and the east after informing the corresponding station of the identification information, and send the services to the west/east WDM line after encapsulating, mapping and framing.

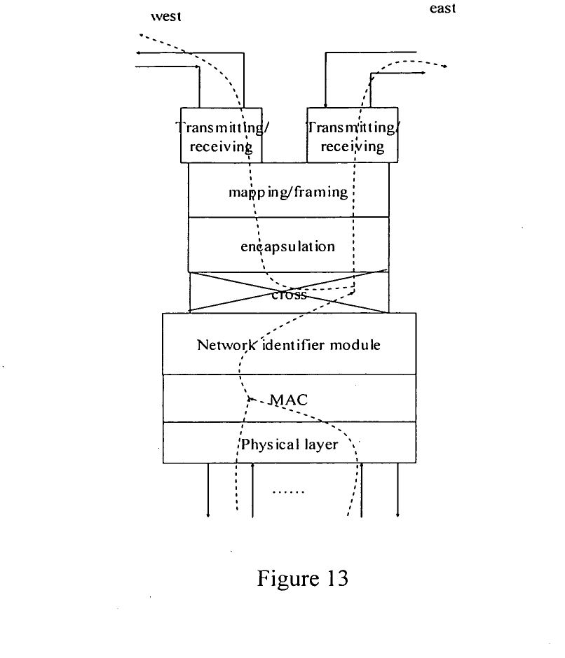

As shown in FIG. 13, in the multicast service receiving stations, the function of the CS is the same as that in the first embodiment, just the implementing procedure of the multicast service receiving station is different from that in the first embodiment. The GE services from different ports at the source station share one GE channel to transmit and are identified in the WDM network to differentiate the GE services from different ports, the procedure of selecting the east/west service and that of the service duplication are the same as those in the first embodiment, however, the reception is performed according to the WDM identifiers, so when the services to be sent to the client side passing the WDM identifier identifying/removing layer, i.e. the network identifier identifying/removing module described above in the device, just selects the services belonging to the present station, removing the identifier and then sending the services to the corresponding client port, while the services not belonging to the present station will be discarded according to the identifiers and the corresponding relationship between the ports and the identifiers that are preset according to the notification from the source station, i.e. the forwarding table. This is the difference from the first embodiment, in which the WDM identifying layer does not need to execute the WDM identifier selection.

In the present embodiment, the duplication of the Ethernet service signals can also be performed by the WDM identifier identifying/removing layer, then it is needed to configure two exports for each self-defining identifier of the WDM network in the forwarding table in the WDM identifier identifying/removing layer, one port is the local export while the other port is for returning the service signals to the WDM network channel through the space-division cross module. As to the service signals not belonging to the present station, the local export can be configured as null. The Space-division cross module only performs the space-division cross upon the service signals, and the WDM identifier identifying/removing layer outputs the service data through the corresponding port according to the forwarding table after duplicating the service signals.

As to the above-illustrated three different types of multicast methods, the first multicast method takes the GE granularity as an unit, while the second method and the third method adopts the shared channel, wherein, the second method differentiates the services of different stations in the shared channels according to the VLAN labels of the GE service itself, but the third method makes use of the self-defined identifier information to differentiate services of different stations.

In specific implementations, the methods of the present invention can be modified accordingly to adapt to specific situations. Thus it can be easily understood that the embodiments according to the present invention are just demonstrations but not used to confine the protection scope of the present invention.

1. A method for transmitting Ethernet service signals in a Wavelength Division Multiplexing (WDM) network, comprising:
a Center Server (CS) receiving the Ethernet service signals and transmitting the signals to a transmission channel for transmission;
a receiving station receiving the Ethernet service signals from the transmitting channel, performing a space-division cross operation upon the received signals and duplicating the signals into two copies, wherein one copy is locally downloaded and the other copy is returned to the transmission channel for continuous transmission.

2. The method according to claim 1, wherein,
the CS transmits the Ethernet service signals in any direction of the transmission channel or in both directions of the transmission channel simultaneously; and
each receiving station receives the Ethernet service signals from any direction of the transmission channel or from both directions of the transmission channel simultaneously.

3. The method according to claim 2, further comprising:
each station implementing a protection switch by switching the directions of receiving and transmitting the Ethernet service signals.

4. The method according to claim 1, wherein, the step of duplicating is implemented by a space-division cross module.

5. The method according to claim 1, wherein, the duplication is implemented by a Media Access Control (MAC) layer according to a MAC layer label and the a pre-configured forwarding table, or the step of duplicating is implemented by a network identifier module according to a self-defined identifier added to the Ethernet service signals and the pre-configured forwarding table.

6. The method according to claim 1, further comprising:
when the CS receives multiple Ethernet service signals at the same time,
the CS determining that the Ethernet service signals carry different MAC layer labels respectively; informing the receiving station of the MAC layer labels carried in each Ethernet service signal; and transmitting the multiple Ethernet service signals to the transmission channel; and
the receiving stations receiving the multiple Ethernet service signals, selecting the signals belonging to the present station from the locally downloaded multiple Ethernet service signals to receive and discarding signals not belonging to the present station according to the MAC layer labels.

7. The method according to claim 2, further comprising:
when the CS receives multiple Ethernet service signals at the same time,
the CS determining that the Ethernet service signals carry different MAC layer labels respectively; informing the receiving station of the MAC layer labels carried in each Ethernet service signal; and transmitting the multiple Ethernet service signals to the transmission channel for transmission; and
the receiving stations receiving the multiple Ethernet service signals, selecting the signals belonging to the present station from the locally downloaded multiple Ethernet service signals to receive and discarding signals not belonging to the present station according to the MAC layer labels.

8. The method according to claim 6, wherein: the MAC layer label is a Virtual Local Area Network (VLAN) label, or a Multiple-Protocol Label Switching (MPLS) label or a Resilient Packet Ring (RPR) label.

9. The method according to claim 1, further comprising:
when the CS receives multiple Ethernet service signals at the same time,
the CS adding an identifier of the station that receives the service signals into each Ethernet service signal; correspondingly informing each receiving station of the identifier; and transmitting the multiple Ethernet service signals to the transmission channel for transmission;
the receiving station receiving the multiple Ethernet service signals, selecting the signals belonging to the present station from the locally downloaded multiple Ethernet service signals to receive and discarding the signals not belonging to the present station according to the identifier information; and peeling the identifier information from the signals of the present station.

10. The method according to claim 2, further comprising:
when the CS receives multiple Ethernet service signals at the same time:
the CS adding the identifier of the station that receives the service signals into each Ethernet service signal; correspondingly informing each receiving station of the identifier; and transmitting the multiple Ethernet service signals to the transmission channel for transmission;
the receiving station receiving the multiple Ethernet service signals, selecting the signals belonging to the present station from the locally downloaded multiple Ethernet service signals to receive and discarding the signals not belonging to the present station according to the identifier information; and peeling the identifier information from the signals of the present station.

11. A device for transmitting Ethernet service signals in a Wavelength Division Multiplexing (WDM) network, comprising:
transmitting/receiving modules, which connect to transmission channels in the WDM network;
a local service processing part, which connects to a user side; and
a space-division cross module, connected with the transmitting/receiving module and the local service processing part, and is used for performing a space-division cross operation upon the Ethernet service signals and duplicating the Ethernet service signals;
wherein, the Ethernet service signals at network side received by transmitting/receiving module are duplicated by the space-division cross module into two copies, wherein one copy is transmitted to the local service processing part and the other copy is returned to the network side for continuous transmission.

12. The device according to claim 11, wherein, the local service processing part comprises a Media Access Control (MAC) layer and a physical layer, wherein, the MAC layer connects to the space-division cross module and the physical layer, selects the services that belong to the present station and to receive according to MAC layer labels, and discards other services.

13. The device according to claim 11, further comprising:
a network identifier module, connected with the space-division cross module and the local service processing part, and is used for adding identifiers to the Ethernet service signals, selecting services that belong to the present station to receive according to the added identifiers, and peeling identifier information of the Ethernet service signals that belong to the present station.

14. The device according to claim 11, further comprising:
an Ethernet service signal encapsulation module and a mapping/framing module, which connect to the cross module and the transmitting/receiving modules.

15. A device for processing Ethernet service signals in a Wavelength Division Multiplexing (WDM) network, comprising:
a transmitting/receiving module, which connects to transmission channels of the WDM network;
a Media Access Control (MAC) layer that connects a user side; and
a space-division cross module, connected with the transmitting/receiving modules and the MAC layer, and is used for performing a space-division cross operation upon the Ethernet service signals;
wherein, the MAC layer is used for duplicating the Ethernet service signals from the space-division cross module into two copies, wherein one copy is transmitted to a local station while the other copy is returned to the transmission channel of the WDM network through the space-division cross module and transmitting/receiving module.

16. The device according to claim 15, wherein, the MAC layer is further used for selecting service signals that belong to the present station to receive according to MAC layer labels in the Ethernet service signals, and discarding other service signals from the space-division cross module which do not belong to the present station.

17. The device according to claim 15, further comprising:
an Ethernet service signals encapsulation module, a happing/framing module, which connect the cross module and the transmitting/receiving module.

18. A device for processing Ethernet service signals in a Wavelength Division Multiplexing (WDM) network, comprising:
a transmitting/receiving module, which connects to transmission channels in the WDM network;
a local service processing part that connects the a user side; and
a space-division cross module, connected with the transmitting/receiving module and the network identifier module, and is used for performing a space-division cross operation upon the Ethernet service signals;
a network identifier module, which is used for duplicating the Ethernet service signals into two copies, removing the identifier of one copy and sending the signals to the local service processing part, and returning the other copy to the transmission channel of the WDM network through the space-division cross module and transmitting/receiving modules for continuous transmission.

19. The device according to claim 18, wherein, the network identifier module is further used for selecting services that belong to the present station according to self-defined identifiers of the service signals, peeling the identifiers and transmitting the signals to the local service processing part.

20. The device according to claim 18, wherein, the local service processing part comprises a MAC layer and a physical layer, wherein,
the MAC layer receives the Ethernet service signals from the network identifier module, selects the services that belong to the present station to receive according to MAC layer labels in the Ethernet service signals and discarding other services.

21. The device according to claim 18, further comprising:
an Ethernet service signal encapsulation module, and a mapping/framing module, which connects the cross module and the transmitting/receiving modules.
